(19) United States
(12) Patent Application Publication
(10) Pub. No.: US 2026/0309984 A1
(43) Pub. Date: Oct. 8, 2026

(54) FRAME-BASED LIGHT NOTIFICATIONS ON A WEARABLE DEVICE

(71) Applicant: Google LLC, Mountain View, CA (US)

(72) Inventors: Shiblee Hasan, Santa Clara, CA (US); Natalie Sonsogno Hirano, Waterloo (CA); David Meisenholder, Playa Vista, CA (US)

(21) Appl. No.: 19/098,703

(22) Filed: Apr. 2, 2025

(51) Int. Cl. G02B 27/01; G02B 27/00

(52) U.S. Cl. CPC G02B 27/0172; G02B 27/0093; G02B 27/0176; G02B 2027/014; G02B 2027/0178

(57) ABSTRACT

According to at least one implementation, a system includes a frame of a head-worn device and a controller. The system further includes at least one light-emitting diode (LED) positioned on a portion of the frame facing a user of the frame, the at least one LED configured to emit light, at least partially, in a direction of an eye of the user based on an instruction from the controller.

### BACKGROUND

A head-worn device can include an electronic or mechanical system designed to be worn on the head, which can incorporate sensors, displays, or communication features to enhance user experience in various applications. These devices range from virtual reality (VR) and augmented reality (AR) headsets, which immerse users in digital environments, to smart glasses that overlay digital information onto the real or physical world. Other examples include head-worn cameras for hands-free recording, communication headsets for audio transmission, and medical or assistive technologies. The devices can enhance how users perceive and interact with their surroundings.

### SUMMARY

This disclosure relates to systems and methods for providing notifications on a wearable device using lights located in the frame of the device. In some implementations, a head-worn device can include a frame that provides structural support for electronic components while the user wears the device. In some examples, the frame can include at least one light-emitting diode (LED) on a portion of the frame facing the user. The at least one LED can be configured to emit light, at least partially, in the direction of the user's eye based on a controller's instruction. In some examples, the at least one LED comprises a direct view display representing a screen technology where the image is produced and viewed directly on the emitting surface without the need for projection or backlighting. In some implementations, the system can further include a diffusion layer configured to blend the light from the at least one LED based on the instruction from the controller. In some implementations, the system can further include a liquid crystal (LCD) layer configured to mask the light from the at least one LED based on the instruction from the controller.

In some aspects, the techniques described herein relate to a system including: a frame of a head-worn device; a controller; and at least one light-emitting diode (LED) positioned on a portion of the frame facing a user of the frame, the at least one LED configured to emit light, at least partially, in a direction of an eye of the user based on an instruction from the controller.

In some aspects, the techniques described herein relate to a method including: generating an instruction for at least one light-emitting diode (LED) positioned on a portion of a frame of a head-worn device; and emitting, from the at least one LED, light, at least partially, in a direction of an eye of a user of the head-worn device based on the instruction.

In some aspects, the techniques described herein relate to a system including: a frame of a head-worn device; a controller; a display in a lens of the frame, the display including at least one optical component; and at least one light-emitting diode (LED) positioned on a portion of the frame facing a user of the frame, the at least one LED configured to emit light, at least partially, in a direction of an eye of the user based on an instruction from the controller.

The details of one or more implementations are outlined in the accompanying drawings and the description below. Other features will be apparent from the description, drawings, and claims.

### BRIEF DESCRIPTION OF THE DRAWINGS

FIG. 1A illustrates a head-worn device at a side view for providing frame-based LED notifications to a user according to an implementation.

FIG. 1B illustrates a head-worn device from a user perspective with frame-based LED notifications according to an implementation.

FIG. 1C illustrates a head-worn device from an outside perspective with frame-based LED notifications according to an implementation.

FIG. 2 illustrates a method of operating a head-worn device to provide frame-based LED notifications according to an implementation.

FIG. 3 illustrates a configuration of a head-worn device to provide notifications according to an implementation.

FIG. 4 illustrates a configuration of a head-worn device to provide notifications according to an implementation.

FIG. 5 illustrates an operational scenario of updating a configuration for at least one LED according to an implementation.

FIG. 6 illustrates an operational scenario of updating a configuration for at least one LED according to an implementation.

FIG. 7 illustrates examples of LED configurations for a head-worn device, according to a few implementations.

FIG. 8 illustrates a computing system that provides notifications via at least one LED according to an implementation.

### DETAILED DESCRIPTION

A head-worn device is a wearable apparatus positioned on or around a user's head, incorporating one or more functional components for visual, auditory, or sensory interaction. The device may include a structural support element, such as a frame, band, or harness, configured to secure the device while accommodating ergonomic and comfort considerations. In some examples, the head-worn device integrates optical elements, such as a display module or lenses, to provide augmented reality (AR), virtual reality (VR), or heads-up display (HUD) functionality. The lenses can use optical technologies like waveguides, holographic optics, or convex magnification to project or enhance digital images, blending them with reality (AR) or creating an immersive virtual world (VR). The device may also include sensors for motion tracking, biometric monitoring, or environmental awareness, enabling adaptive and interactive experiences.

The head-worn device may further comprise a controller or control module, which can include a processor, memory, and wireless communication components, allowing for data processing and connectivity with external systems. The external systems can include companion devices like smartphones, tablets, or other computing devices. In some implementations, audio output elements, such as speakers or bone conduction transducers, may be embedded within the structure to deliver sound without obstructing ambient awareness. Additionally, input mechanisms, including touch-sensitive surfaces, gesture recognition modules, or voice command interfaces, may be incorporated to facilitate user interaction. The device may be powered by an integrated battery, rechargeable through wired or wireless means, and may include cooling mechanisms to manage thermal dissipation. The head-worn device can be utilized in various applications, including but not limited to immersive entertainment, navigation assistance, hands-free computing, and health monitoring. However, at least one technical problem exists in efficiently providing notifications to a device user without obstructing a current activity. For example, in smart glasses, it can be desirable to notify a user without obstructing the view through the lenses or providing an audible notification.

As at least one technical solution, a head-worn device can be configured with at least one LED positioned on a portion of the head-worn device frame facing the user, and the LED can be configured to emit light in a direction toward the eye of the user. When a controller for the head-worn device generates an instruction or a notification, the LED can emit light toward the user's eye to provide the notification. The light from the LED is not projected or supplied via a diffractive or reflective optical component embedded in the lenses of the head-worn device. In some implementations, the device can include an LED for each eye to give the notification. In some implementations, an LED is available on one side of the frames, such that a first eye (e.g., right eye) can view the notification while the second eye cannot (e.g., left eye).

In some examples, the at least one LED provides light through a diffusion layer before being viewed by the user of the head-worn device. A diffusion layer is a material or surface that scatters and distributes light from the LED more evenly, reducing glare and creating a softer, more uniform illumination. It can be made from frosted glass, diffusive plastics, or special coatings that help eliminate hotspots and harsh shadows. This layer can enhance visual comfort and improve the aesthetics of LED lighting from the at least one LED positioned on the frame.

In some implementations, a system can employ a liquid crystal display (LCD) in addition to or in place of the diffusion layer. An LCD layer can be used to manipulate light and create images. While LEDs provide the backlight, the LCD layer consists of liquid crystals that rotate polarized light to control how much light passes through. This allows the device to produce different colors and images by selectively blocking or allowing light to pass through color filters. For example, based on a command from a controller, the LCD layer can manipulate the light from at least one LED to create images or characters to notify the user. In some implementations, if the user provides a request, the notification can provide feedback to the user. For example, the user can request an increase in the audio volume supplied by the head-worn device (e.g., a voice request recognized via a microphone associated with the device). In response to the request, at least one LED combined with the LCD layer can notify the user that the request was identified, and the action was taken (e.g., displaying an up arrow for increasing the volume). In some implementations, the LCD layer may include a color that blends or resembles the color of the frames of the glasses. For example, when no content is provided via the at least one LED, the LCD layer can be used to prevent user distraction by blending the light emitting source into the frame of the head-worn device.

In some examples, the at least one LED can comprise a direct view display for the user. A direct view display is a display technology in which images are generated and viewed directly from the surface of the display panel without requiring additional optical projection systems. This permits the at least one LED or array of LEDs to notify the user without providing the information via the device's lens. As at least one technical effect, rather than turning on a primary display that can be supplied via projectors, lenses, and embedded waveguides on the device, the notification can be provided as a separate interface facing the user and located in the frames of the head-worn device. In some implementations, notifications can be provided in addition to the content displayed on the device. In some implementations, the device can provide notifications without any content on the lenses. For example, the head-worn device can comprise glasses that do not provide content on the lenses of the glasses. Instead, notifications (e.g., volume up, incoming message, etc.) can be provided via at least one LED on a portion of the frame facing the user of the glasses.

In some implementations, the controller of the head-worn device can be coupled to one or more sensors that modify the configuration of the light provided as part of the notifications. The sensors can detect information about the light in the physical environment (e.g., temperature and/or brightness) and the gaze location associated with the device user. A head-worn device can incorporate gaze-tracking technology using infrared sensors, cameras, or electrooculography (EOG) sensors to monitor eye movement and pupil position. The system captures corneal reflections or electrical activity to determine gaze direction in real time. Based on the environment light and/or the user gaze, the device can change the configuration associated with the light from the at least one LED positioned in the device's frame. For example, based on the amount of light or temperature of light in the physical environment, the controller can be configured to determine the brightness from the at least one LED. When the device is in a dimly lit environment, at least one LED can have a lower brightness than when the device is in a well-lit environment. Other changes can include changes to the diffusion layer or LCD configuration. In another example, based on the user's gaze, the controller can determine which LED or set of LEDs to provide a notification. Thus, if the device had a first set of LEDs on the right side of the frame and a second set of LEDs on the left side of the frame, the controller could select which of the LEDs to illuminate based on the gaze. The controller can determine the brightness, the subset of LEDs to be illuminated, configurations of the diffusion layer, configurations of the LCD layer, or some other configuration based on the sensor data.

In some implementations, the at least one LED is positioned in or on the frame, such that the light emitted appears to originate from the frame. In some examples, a layer, such as a diffusion layer or LCD layer, can permit the structure of the LED to appear as a similar color to that of the frames. When an instruction is provided by the controller, the LED emits light at least partially toward the user, wherein the light appears from the user perspective to originate from the frame.

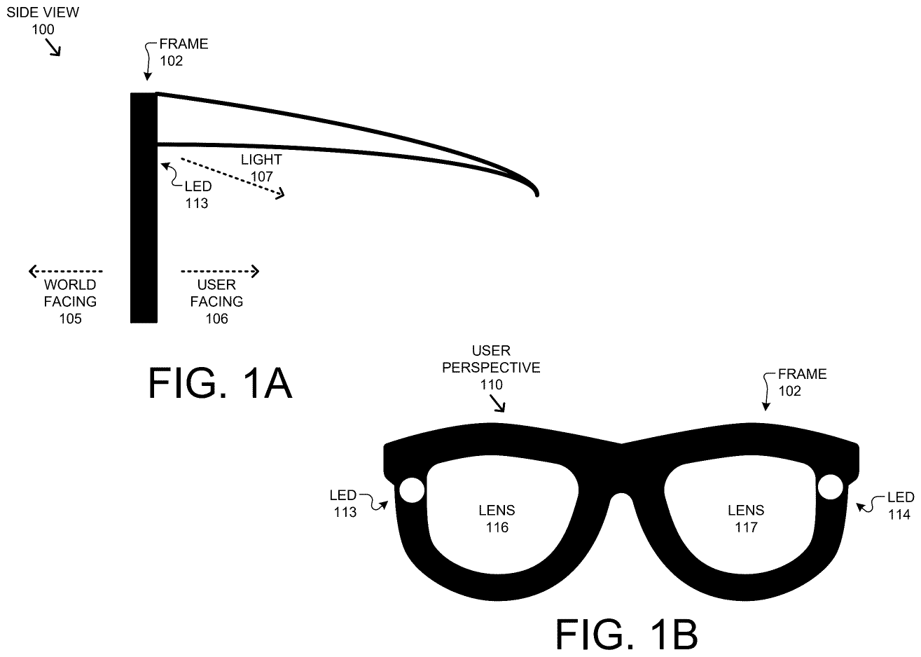

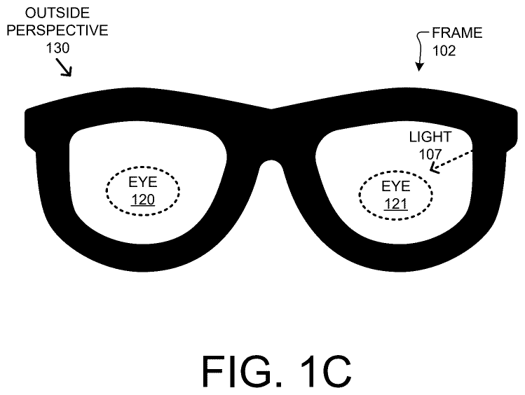

FIG. 1A illustrates a head-worn device at a side view 100 for providing frame-based LED notifications to a user according to an implementation. Side view 100 includes frame 102, directions for world facing 105 and user facing 106, light 107, and LED 113. LED 113 is positioned on a portion of the frame facing a user of the frame (user facing 106) and configured to emit light, at least partially, in the direction of the eye of the user based on an instruction from a controller (not pictured). In some implementations, LED 113 is positioned near a temple portion of the head-worn device and frame 102. In some implementations, LED 113 is representative of a direct view display. A direct view display is a screen that produces images (or light for the user) using self-emissive light, such as LEDs, without the need for a backlight or external projection system. The direct display makes the light visible on the frame and not projected on the lenses associated with frame 102. Light 107 is emitted from LED 113 at least partially toward the eye of the user wearing frame 102. In some implementations, a device can use multiple LEDs configured in an array rather than a single LED. In some implementations, diffusion and/or LCD layers can modify the light emitted from LED 113. A diffusion layer is a component that scatters or distributes light uniformly across a display or optical system to enhance brightness, reduce glare, and improve visual consistency. The diffusion layer can distribute the light across a surface or portion of frame 102 facing the user. The LCD layer can control light from an LED array by adjusting transparency to create images or shapes.

In operation, LED 113 (and optionally the diffusion layer and LCD layer) are coupled to a controller for the head-worn device. The controller of the head-worn device can be configured to process sensor inputs, manage power, and coordinate display, communication, and user interactions. It can be configured to regulate components such as gaze identification, motion sensors, and wireless connectivity, permitting the device to operate for the user. Here, the controller can be configured to generate an instruction to emit light from LED 113. The instruction can indicate various information, including brightness and color associated with LED 113, changes to any diffusion layer for the LED 113, changes to the LCD layer associated with LED 113, or another configuration parameter associated with the LED and any layers related to the LED.

In some implementations, the controller for a head-worn device can be located within the main housing of the device, such as in the temple arms, headband, or behind the ear, to optimize weight distribution and minimize user discomfort. Alternatively, it may be housed in an external module or companion device, such as a handheld remote, a wrist-mounted interface, or integrated into a smartphone application, allowing for flexible control and enhanced user interaction. When a notification is required for the user (e.g., message notification, change of song, camera capture, etc.), the controller can generate a notification for the one or more LEDs, permitting the LEDs to provide the notification to the user.

FIG. 1B illustrates the head-worn device from a user perspective 110 with frame-based LED notifications according to an implementation. FIG. 1B includes frame 102 with LED 113. User perspective 110 further includes LED 114, representing a light or notification source for the other side of the wearable device. Although demonstrated with an LED on both sides of frame 102, a head-worn device can include an LED on a single side of the device.

In FIG. 1B, in response to an instruction from a controller, LED 113 and/or LED 114 can be configured to provide a notification to the user using emitted light. In some implementations, the controller can notify a single LED of LEDs 113 and 114. In other implementations, the controller can notify both LEDs 113 and 114 to provide a notification. Although demonstrated with a single LED for each of LEDs 113 and 114, LEDs 113 and 114 can represent an array of LEDs. In some examples, LEDs 113 and 114 can emit light through a diffusion or LCD layer that manipulates the light from the corresponding LED. The controller (not pictured) can be configured to control the brightness and color associated with LEDs 113 and 114, changes to any diffusion layer for the LEDs 113 and 114, changes to the LCD layer associated with LEDs 113 and 114, or another configuration parameter associated with the LEDs and any layers related to the LED.

In some implementations, the controller can be configured to select an LED from LEDs 113-114 to display the notification. In some examples, the controller can identify a user's gaze and provide the notification, such that the notification is visible in the user's gaze. As a technical effect, one of the LEDs can emit light for the notification while the second light remains inactive or off. The controller can further provide instructions for the diffusion layer to diffuse the light associated with the LED or generate a shape or character associated with the notification. For example, if the user generates a voice request to increase the volume associated with music. The device can be configured to identify the voice request using at least one microphone, implement the requested change in volume, and provide feedback via at least one LED of LEDs 113 and 114. In some implementations, the feedback can include emitting light with a specified brightness and/or color, diffusing the light using a diffusion layer, or providing a shape (e.g., up arrow), indicating the volume change.

In some implementations, the controller can be coupled to a light sensor that determines the light in the physical environment. From the light measurement, the controller can determine a brightness or color associated with the LED and indicate the brightness or color in the instruction. In some examples, the controller can increase or decrease the brightness such that the LED is visible to the user in the physical environment but is not intrusive based on the light in the environment (e.g., not too bright in a dark room). In some implementations, the controller can determine the light temperature in the environment and similarly configure the LED to limit the intrusiveness of the LED. Light temperature, which can be measured in Kelvin (K), describes the color appearance of light, ranging from warm yellow (2000K) to neutral white (4000K) to cool blue (6500K)

FIG. 1C illustrates the head-worn device from an outside perspective 130 with frame-based LED notifications according to an implementation. Outside perspective 130 includes frame 102 with light 107, eye 120, and eye 121. Eye 120 and eye 121 may not be visible from the outside perspective in some examples.

In operation, a controller (not pictured) generates an instruction to emit light 107 from an LED 113 (not pictured). In some implementations, the instruction is used to provide a notification via light 107 to the device user. The controller can include a processor, memory, and wireless communication components, allowing for data processing and connectivity with external systems. The external systems can consist of companion devices like smartphones, tablets, or other computing devices that support the operation of the head-worn device. In some examples, the instruction indicates a brightness and a color for light 107. For example, a controller can identify an incoming message for the user and generate an instruction for the LED to provide light 107, wherein the instruction includes a color and/or brightness for light 107. In some examples, light 107 passes through a diffusion or LCD layer that modifies the light provided to eye 121. The controller can be configured to update the diffusion layer or the LCD layer to provide the user with a notification. The diffusion layer can disperse emitted light to reduce glare, enhance illumination consistency, and improve optical efficiency. The LCD layer can modify the light to provide shapes and letters to the device user.

Although demonstrated as providing a notification as light 107 to a single eye 121, a head-worn device can include multiple LEDs that offer notifications. For example, a first set of one or more LEDs can provide notifications to a first eye, while a second set can provide notifications to a second eye. In some implementations, the controller can select which of the LEDs to emit light based on the type of notification supplied, sensor information, or some other factor. In some examples, the controller can identify a first notification and generate an instruction for a first LED (or set of LEDS), determine a second notification, and generate an instruction for a second LED (or set of LEDs). The different LEDs can be used to indicate the content of the notification. For example, the first LED can indicate an incoming message, while the second LED can indicate a change in audio (e.g., an increase in volume). In some implementations, sensors can collect information about the environment and determine a configuration associated with the one or more LEDs of the device. The sensors can identify the user's gaze or the lighting characteristics of the physical environment. From the sensor information, the controller can determine which of the LEDs to emit light, the brightness of the LEDs, the color, the configuration associated with a diffusion layer, and the configuration associated with any LCD layer. For example, the brightness can be adjusted based on the brightness of the surrounding room. As another example, the controller can be configured to select an LED to display a notification based on the current gaze. As at least one technical effect, the operation permits an LED or set of LEDs to be selected to limit distraction to the device user.

In some implementations, LED 113 and 114 of FIGS. 1A and 1B can be positioned such that light 107 is directed at least partially at the user without projecting the light on lens 116 or lens 117. As at least one technical effect, this permits notifications to be provided to the user without using the device's lens (or primary screen). Additionally, when the head-worn device does not include a primary screen, notifications can be provided without obstructing the user's view of the physical environment. In some examples, the light from the LED can appear to the user as originating from a portion of the head-worn device frame. Thus, the notifications are indicated from the frame itself and not the device's lenses.

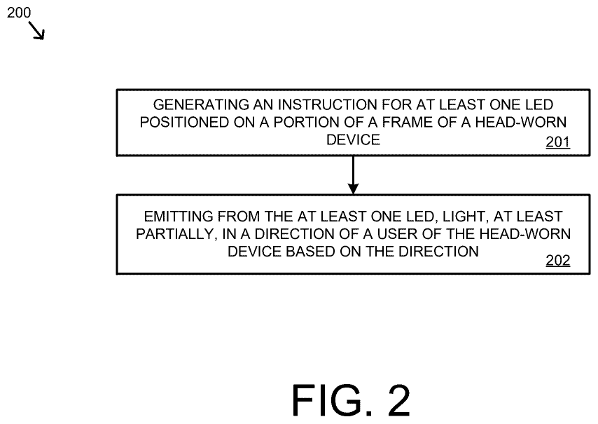

FIG. 2 illustrates method 200 of operating a head-worn device to provide frame-based LED notifications according to an implementation. The steps of method 200 are referenced parenthetically in the paragraphs that follow.

Method 200 includes generating (201) an instruction for at least one light-emitting diode (LED) positioned on a portion of a frame of a head-worn device. In some implementations, a head-worn device can be configured with a controller. The controller can include a processing unit configured to manage device operation, process user inputs, and facilitate interaction with the device's components. The controller may include a hardware interface, such as a handheld remote, integrated touchpad, or physical buttons, and/or a software interface enabling control via voice commands, gesture recognition, or eye movement. The controller can be configured to receive input signals, execute corresponding commands, and communicate with the device's sensors, display (including available LEDs), and communication modules. In some examples, the system can include at least one LED positioned on a portion of the frame for the head-worn device facing the device user and emitting light in a direction of the user's eye. In some implementations, rather than displaying content on the device lens or screen via projection (e.g., VR) or projection via optical component like a waveguide or hologram (e.g., AR), the at least one LED can provide notifications and information to the user as a secondary source. The light from the at least one LED can be visible as part of a direct view display in some examples. The light can appear to the user as originating from at least a portion of the frame in some examples.

Method 200 further includes emitting (202), from the at least one LED, light, at least partially, in a direction of an eye of a user of the head-worn device based on the instruction. In some implementations, the at least one LED is located such that the user's eye receives the light as part of a direct view display. The LED is not projected or included in the device's lenses. In some implementations, an LCD layer modifies the light from the at least one LED. The LCD layer can be colored to resemble or be a close shade associated with the device frame. When an instruction is generated (e.g., to provide a notification for an incoming message), the device can be configured to emit light from the at least one LED and update the LCD layer to mask the light from the at least one LED. Masking can provide a shape or letter to the device user to indicate the notification. For example, when the user verbally requests the volume to be reduced from speakers associated with the device, the controller can be configured to provide an instruction to generate the display of a down arrow using a combination of the emitted light from the LED and the masking layer provided by the LCD layer.

In some implementations, the controller can be configured to determine a state associated with a primary display (e.g., display provided via the device's lens). When the primary display is in an off or standby state, the controller can direct notifications to the at least one LED. When the primary display is active, the controller can direct the notification to be provided via the primary display. As at least one technical effect, rather than using power associated with the primary display to give a notification, an LED can provide the notification to the user.

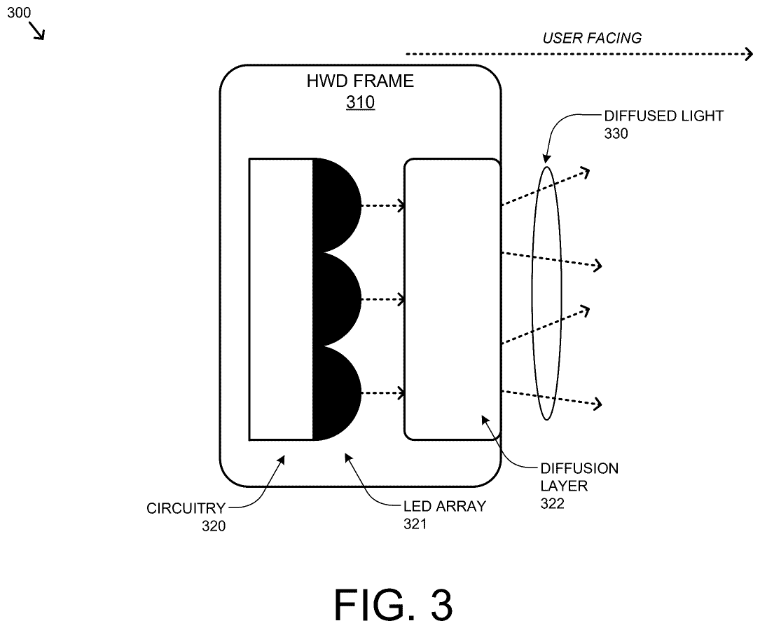

FIG. 3 illustrates a configuration 300 of a head-worn device to provide notifications according to an implementation. Configuration 300 included head-word device (HWD) frame 310 and diffused light 330. Head-worn device frame 310 further includes circuitry 320, LED array 321, and diffusion layer 322. LED array 321 can include one or more LEDs positioned in a portion of head-worn device frame 310 facing the user of the frame and configured to emit light at least partially in the direction of the eye of the user based on an instruction from a controller (not pictured). LED array 321 can be positioned in a portion of the frame such that light from LED array 321 is visible without being projected or guided (via waveguide) to a lens of the device. In some implementations, LED array 321 represents a secondary display that can provide notifications independent of a primary display. The primary display can present digital content to the user using high-resolution displays. These can be combined with optical elements like waveguides or lenses to project immersive augmented, virtual, or mixed reality experiences while maintaining clarity, depth perception, and responsiveness to user interactions. In some implementations, the device can include lenses that do not provide content (e.g., vision lenses). In this example, LED array 321 can provide notifications in a less intrusive manner by giving a direct view display from the frame and not producing content on the lenses of the glasses. In some examples, LED array 321 is positioned, such the light appears to the user as originating from the frame of the device.

In operation, the controller identifies a notification to be provided to the device user and, in response to identifying the notification, communicates a command to LED array 321 via circuitry 320. Circuitry 320 can include driver circuitry, such as constant current drivers or pulse-width modulation (PWM) controllers, to regulate brightness and color. Circuitry 320 can, in the case of multiple LEDs provide color gradients and animations, such as blinking or pulsing. Power management circuitry can provide stable voltage and current, while control circuitry, implemented via microcontrollers, field programmable gate arrays (FPGAs), or other processing systems, can process input signals to manage LED activation and effects. The notification can include incoming messages, calls, or alerts, system status updates, environmental changes, user interactions, and application-specific events. For example, when the controller identifies an incoming message, the controller can generate an instruction to emit light from the LED array 321. Here, light from LED array 321 is passed through diffusion layer 322 to generate diffused light 330. Diffusion layer 322 scatters and redistributes emitted light to enhance uniformity and reduce hotspots. Diffusing light minimizes glare and creates a more homogeneous illumination pattern, improving visibility and aesthetics. This layer can be composed of materials such as frosted glass, diffusive plastics, or microstructures that alter the angular distribution of light while maintaining efficiency. In some implementations, diffusion layer 322 can be communicatively coupled to the controller. It can be dynamically configured using adjustable materials or mechanisms such as liquid crystal films, electrochromic coatings, or mechanically tunable diffusers. By modulating these elements, the controller can alter the diffusion properties in real time, adjusting light distribution, intensity, and uniformity based on environmental conditions or preferences. For example, based on environmental conditions (e.g., an amount of light in the physical environment), the diffusion layer 322 can adjust light distribution from LED array 321. In some implementations, the diffusion can be based on preferences associated with the incoming notification. For example, a first diffusion configuration can be used for a first type of notification (e.g., incoming message), and a second diffusion configuration can be used for a second type of notification (e.g., change of volume).

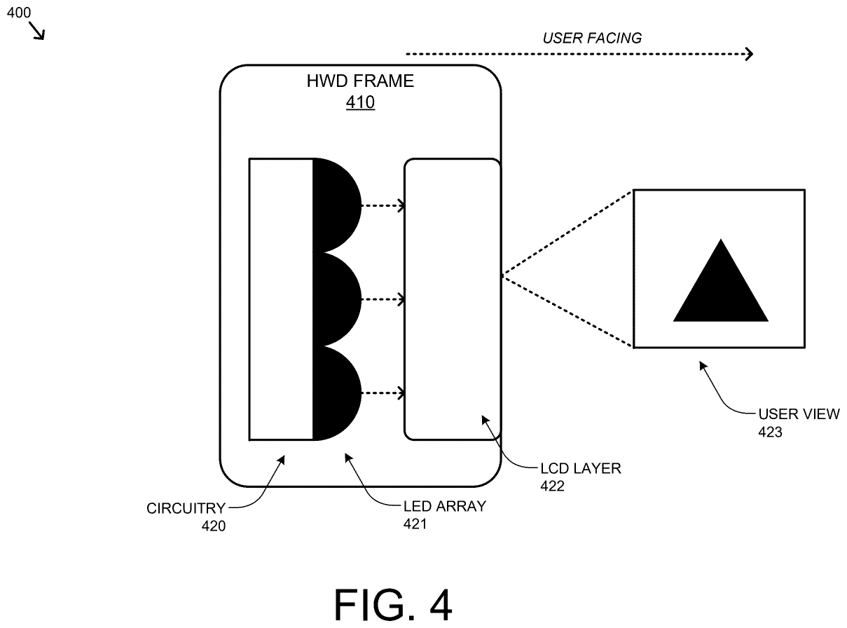

FIG. 4 illustrates a configuration 400 of a head-worn device to provide notifications according to an implementation. Configuration 400 included head-word device (HWD) frame 410 and user view 423. Head-worn device frame 410 further includes circuitry 420, LED array 421, and diffusion layer 422. LED array 421 can include one or more LEDs positioned in a portion of head-worn device frame 410 facing the user of the frame and configured to emit light at least partially in the direction of the eye of the user based on an instruction from a controller (not pictured). LED array 421 can be positioned in a portion of the frame such that light from LED array 421 is visible without being projected or guided (via waveguide) to a lens of the device. In some implementations, LED array 421 represents a secondary display that can provide notifications independent of a primary display. The primary display can present digital content to the user using high-resolution displays. These can be combined with optical elements like waveguides or lenses to project immersive augmented, virtual, or mixed reality experiences while maintaining clarity, depth perception, and responsiveness to user interactions. In some implementations, the device can include lenses that do not provide content (e.g., vision lenses). In this example, LED array 421 can provide notifications in a less intrusive manner by providing a direct view display from the frame and not producing content on the lenses of the glasses. The light may appear as originating from the frame and not the primary display or lens of the device.

In operation, the controller identifies a notification to be provided to the device user and, in response to identifying the notification, communicates a command to LED array 421 via circuitry 420. Circuitry 420 can include driver circuitry, such as constant current drivers or pulse-width modulation (PWM) controllers, to regulate brightness and color. Power management circuitry can provide stable voltage and current, while control circuitry, implemented via microcontrollers, field programmable gate arrays (FPGAs), or other processing systems, can process input signals to manage LED activation and effects. The notification can include incoming messages, calls, or alerts, system status updates, environmental changes, user interactions, and application-specific events. For example, when the controller identifies an incoming message, the controller can generate an instruction to emit light from the LED array 421.

Here, light from LED array 421 is passed through LCD layer 422. LCD layer 422 modulates light transmission by selectively adjusting the alignment of liquid crystal molecules in response to electrical signals. This enables dynamic control over brightness, contrast, and transparency, allowing for adaptive dimming, selective diffusion, or pattern generation. The LCD layer can enhance optical performance, reduce glare, and enable customizable visual effects. In some implementations, LCD layer 422 is controlled by the controller, permitting the controller to allow the emission of light from LED array 421 and modify the light using LCD layer 422. For example, in response to a request to update the audio volume from the device, the controller can generate an instruction to emit light from LED array 421 via circuitry 420 and update LCD layer 422 to provide user view 423. User view 423 represents a direct view display that does not obstruct the lens or lenses of the head-worn device. In some implementations, user view 423 is presented between a first portion of the frame (e.g., outer portion) and a second portion of the frame (inner portion). In some implementations, LED array 421 and LCD layer 422 can be located near a temple portion of the head-mounted device. In some implementations, the display from LED array 421 and LCD layer 422 can be provided without providing content on the lens of the display (e.g., a primary display in an off or standby mode). In some implementations, the head-worn device can comprise a primary display provided via projectors and/or waveguides and LED array 421 can provide supplemental notifications independently of the primary display. In some implementations, the head-worn device can comprise clear lenses and LED array 421 provides a direct display of the notifications based on the information from the controller. In at least one implementation, LED array 421 is embedded in a portion of the frame, and the light is emitted at least partially toward the eye of the user without the use of waveguides or projection systems.

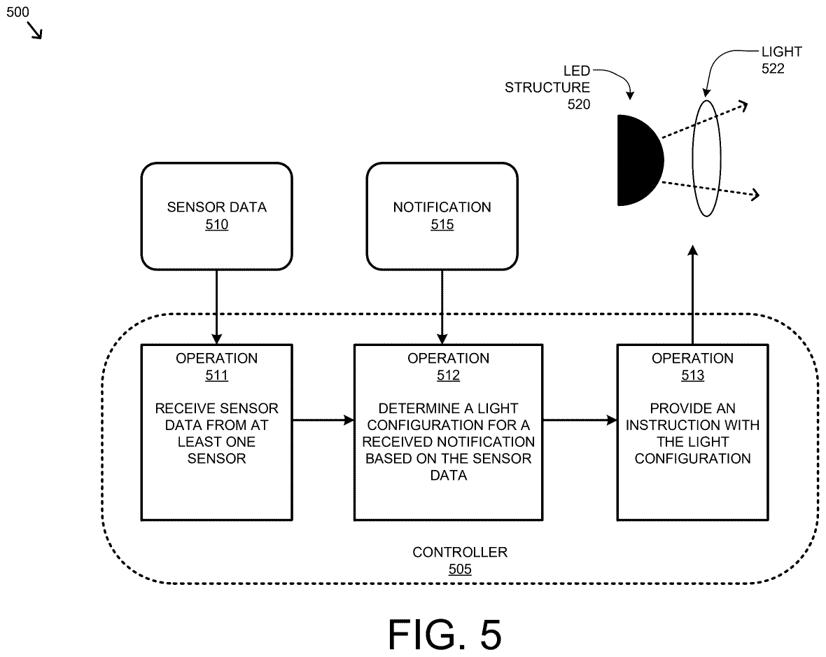

FIG. 5 illustrates an operational scenario 500 of updating a configuration for at least one LED according to an implementation. Operational scenario 500 includes sensor data 510, notification 515, controller 505, LED structure 520, and light 522. Controller 505 represents a controller for a head-worn device and provides operations 511, 512, and 513. LED structure 520 can include an LED array with at least one LED, a diffusion layer, an LCD layer, circuitry, or other elements to provide light 522. LED structure 520 represents one or more LEDs positioned on a portion of the frame of the head-worn device and configured to emit light at least partially in a direct direction of a user's eye of the device.

In operational scenario 500, operation 511 directs controller 505 to receive sensor data 510 from at least one sensor. In some implementations, sensor data 510 is provided from a light sensor and indicates light intensity in the physical environment. In some implementations, sensor data 510 can identify the gaze associated with a device user. Gaze on a head-worn device can be determined using eye sensors, such as infrared cameras or electrooculography (EOG) sensors, which detect eye movements and pupil position. The sensors track the reflection of infrared light from the eyes or measure electrical activity from eye muscles to determine gaze direction. Some advanced systems also incorporate inertial measurement units (IMUs) or motion sensors, and machine learning to improve accuracy.

After receiving the sensor data, controller 505 implements operation 512 to determine a light configuration for a received notification 515 based on sensor data 510. The notification can include incoming messages, calls, or alerts, system status updates, environmental changes, user interactions, and application-specific events. In some examples, the notification can be provided from external devices, such as a companion device (e.g., smartphone). In some implementations, the notification can be generated via software operating on the head-worn device. In response to identifying the notification, operation 512 determines the light configuration, wherein the light configuration may identify an LED or set of LEDs to emit light associated with the notification, a brightness for the LEDs, a color for the LEDs, a configuration associated with a diffusion layer, a configuration associated with an LCD layer, or some other configuration update. The configuration can be based on the notification and the sensor data 510.

In one example, when a first type of notification is received, the device can identify a first set of LEDs to support the notification and instruct the first set of LEDs to emit light with a defined brightness and color. However, when a second type of notification is received, the device can identify a second set of LEDs to support the notification and instruct the second set of LEDs to emit light with a second brightness and color. In another example, the device can change the brightness or color of the LEDs based on environmental information, such as light intensity in the physical environment. In some examples, the user's gaze can select brightness and color from the LEDs or other parameters associated with providing the notification. The controller can choose a method of providing the notification that limits the intrusiveness of the notification (e.g., emitting a bright light at the user's eye).

Once the configuration is determined, operation 513 provides instructions for the light configuration for LED structure 520. In response to receiving the instruction, LED structure 520 can be configured to emit light 522 per the instruction. The instruction can include information about brightness, color, diffusion, LCD manipulation, or some other configuration parameter. In some examples, the instruction can select a set of one or more LEDs for the notification.

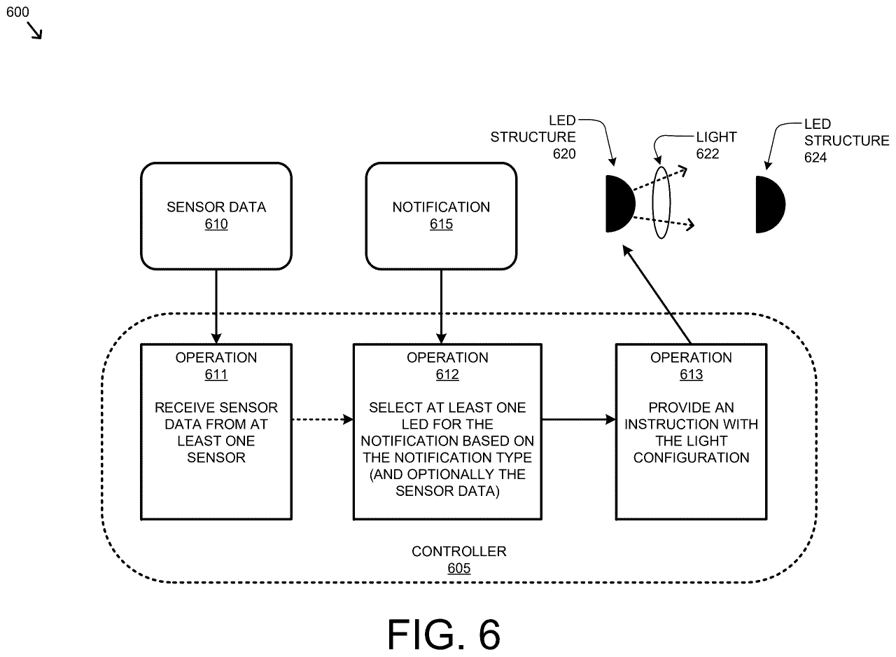

FIG. 6 illustrates an operational scenario 600 of updating a configuration for at least one LED according to an implementation. Operational scenario 600 includes sensor data 610, notification 615, LED structure 620, light 624, and LED structure 624. Controller 605 provides operations 611, 612, and 613. LED structure 620 can include an LED array with at least one LED, a diffusion layer, an LCD layer, circuitry, or other elements to provide light 622. LED structure 520 represents one or more LEDs positioned on a portion of the frame of the head-worn device and configured to emit light at least partially in a direct direction of a user's eye of the device. LED structure 624 can include similar elements.

In operational scenario 500, operation 511 directs controller 505 to receive sensor data 510 from at least one sensor. In some implementations, sensor data 510 is provided from a light sensor and indicates light intensity in the physical environment. In some implementations, sensor data 510 can identify the gaze associated with a device user. Gaze on a head-worn device can be determined using eye movement sensors, such as infrared cameras or electrooculography (EOG) sensors, which detect eye movements and pupil position. The sensors track the reflection of infrared light from the eyes or measure electrical activity from eye muscles to determine gaze direction. Some advanced systems also incorporate inertial measurement units (IMUs) or motion sensors, and machine learning to improve accuracy.

After receiving the sensor data, controller 605 receives notification 615 and provides operation 612 that selects at least one LED for the notification 615 based on the notification type and, optionally, the sensor data 610. In some implementations, operation 612 can select a different LED or set of LEDs to support a notification based on the notification type. Different types of notifications can include incoming messages, calls, or alerts, system status updates, environmental changes, user interactions, and application-specific events. When a first notification type is identified, operation 612 can select a first set of LEDs to display the notification. When a second notification type is identified, operation 612 can select a second set of LEDs to display the notification. Operation 612 can further select color, brightness, diffusion layer characteristics, LCD configuration characteristics (e.g., displaying a shape or letter), or some other configuration associated with the selected LED or set of LEDs.

In some implementations, operation 612 can further consider other information for the display configuration associated with notification 615. The factors can include light measurements for the physical environment, the user's gaze identified via one or more sensors on the device, or some other factor. From the factors, operation 612 can determine brightness, color, diffusion characteristics, LCD configurations, color gradients, animations like gradual color changes or pulsing brightness, and the like.

Controller 605 further provides operation 613 that provides an instruction with the light configuration to LED structure 620 to provide light 622. In the example of operational scenario 600, operation 612 selects LED structure 620 to support the notification and operation 613 provides an instruction to LED structure 620. The instruction can indicate brightness, color, a diffusion layer configuration, an LCD layer configuration, color gradients, animations like gradual color changes or pulsing brightness, or some other characteristic of the light.

In some implementations, controller 605 can be configured to determine a state associated with a primary display (e.g., display provided via the device's lens). The controller can direct notifications to LED structures 620 or 624 when the primary display is off. When the primary display is active, the controller can direct the notification to be provided via the primary display. As at least one technical effect, rather than using power and resources associated with the primary display to give a notification, an LED can notify the user when the primary display is inactive.

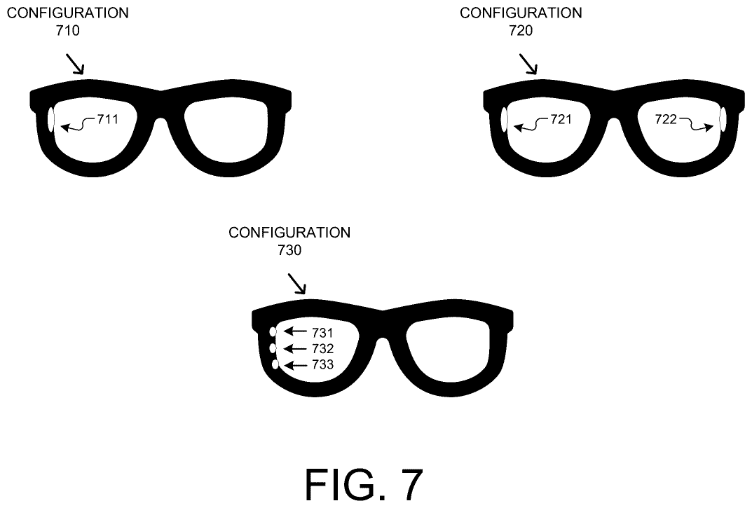

FIG. 7 illustrates example LED configurations for a head-worn device according to a few implementations. FIG. 7 includes configurations 710, 720, and 730, wherein each configuration demonstrates the user perspective of a head-worn device. Referring first to configuration 710, configuration 710 includes LED array 711 on one side of the frame, wherein LED array 711 includes one or more LEDs. LED array 711 is positioned on a portion of the frame facing the user (user's eye) of the frame. LED array 711 emits light, at least partially, in a direction of an eye of a user of the head-worn device based on an instruction from a controller associated with the device. In some implementations, LED array 711 can include a diffusion layer and/or an LCD layer in addition to the one or more LEDs.

In some implementations, the device can include lenses that are at least partially transparent for viewing the physical surroundings and positioned in front of the user's eyes. In some implementations, the device can include a display in the lens portion that can provide content using optical elements, such as waveguides or projection systems. LED array 711 can provide supplemental notifications in addition to or in place of the information provided via the display. For example, if the display is inactive, notifications can be provided via LED array 711, permitting the notification without powering on the primary display. Here, LED array 711 identifies an instruction and emits light based on the instruction. The instruction can include brightness, color, diffusion configuration parameters, LCD parameters, or some other information. In the example, of glasses with transparent lenses, notifications can be provided from the frame of the glasses without intrusively blocking the users view. In some implementations, the light provided appears as though it is emitted from the frame and not part of the lenses.

Configuration 720 includes LED array 721 and LED array 722. LED array 721 and LED array 722 can notify a user like LED array 711. Here, when a notification is identified, an instruction is generated to light one or both of LED array 721 and LED array 722. In some implementations, the LED array is selected based on the type of notification. For example, a first notification can light LED array 721 and a second notification can light LED array 722. In some implementations, the selection can be based on sensor data, such as light in the physical environment or user gaze. The LED array can be selected, such that the notification is visible to the user. The sensor data can also be used to select brightness, color, LCD configuration, and the like.

Configuration 730 includes LED array 731, LED array 732, and LED array 733. LED array 731, LED array 732, and LED array 733 can provide notifications like configuration 720, however, the LED arrays are located on the same side of the device. The different LED arrays can be selected by the controller based on the notification, the sensor data, or based on some other factor. The light emitted from one or more of the LED arrays 731-733 can be based on the notification or sensor data, and can be configured for brightness, color, diffusion, shape, or some other factor.

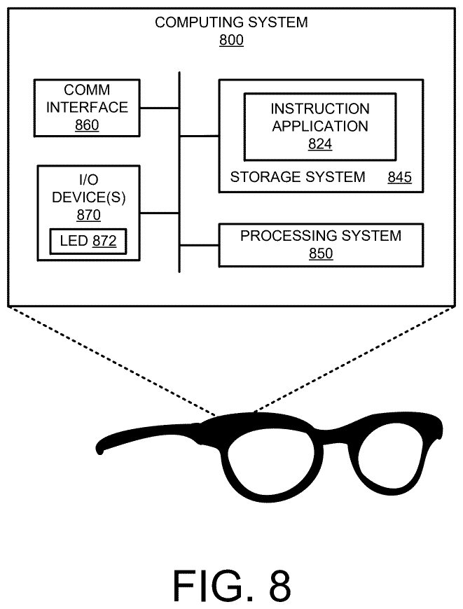

FIG. 8 illustrates a head-worn computing system (computing system) 800 that provides notifications via at least one LED according to an implementation. Computing system 800 represents any computing system or systems with which the various operational architectures, processes, scenarios, and sequences disclosed herein for a wearable device can be implemented. Computing system 800 can represent a head-worn device in some examples. Computing system 800 includes storage system 845, processing system 850, communication interface 860, and input/output (I/O) device(s) 870. Processing system 850 is operatively linked to communication interface 860, I/O device(s) 870, and storage system 845. In some implementations, communication interface 860 and/or I/O device(s) 870 may be communicatively linked to storage system 845. Computing system 800 may further include other components, such as a battery and enclosure, that are not shown for clarity. In some implementations, storage system 845 and processing system 850 represent a controller for a head-worn device as described herein, such as controller 505 from FIG. 5 and controller 605 from FIG. 6.

Communication interface 860 comprises components that communicate over communication links, such as network cards, ports, radio frequency, processing circuitry (and corresponding software), or some other communication devices. Communication interface 860 may be configured to communicate over metallic, wireless, or optical links. Communication interface 860 may be configured to use Time Division Multiplex (TDM), Internet Protocol (IP), Ethernet, optical networking, wireless protocols, communication signaling, or some other communication format-including combinations thereof. Communication interface 860 may be configured to communicate with external devices, such as servers, user devices, or other computing devices.

I/O device(s) 870 may include peripherals of a computer that facilitate the interaction between the user and computing system 800. Examples of I/O device(s) 870 may include keyboards, mice, trackpads, monitors, displays, printers, cameras, microphones, external storage devices, sensors, and the like. I/O device(s) 870 includes LED 872 that is positioned on a portion of the frame facing a user of the frame and configured to emit light, at least partially, in a direction of the eye of the user based on an instruction from processing system 850. In some implementations, the device can include a primary display separate from LED 872. The primary display can use lenses, projection systems, and waveguides to provide information to display content to the user. LED 872 can comprise a direct view display in some examples. In some implementations, LED 872 can emit light as though the light is being emitted from the frame of the device. I/O device(s) 870 can include one or more sensors that provide sensor data associated with lighting in the user's physical environment and gaze associated with the user. The sensors can consist of photodiodes, infrared cameras, and other sensors to identify the information about the user and the environment.

Processing system 850 comprises microprocessor circuitry (e.g., at least one processor) and other circuitry that retrieves and executes operating software (i.e., program instructions) from storage system 845. Storage system 845 may include volatile and nonvolatile, removable, and non-removable media (or medium) implemented in any method or technology for storage of information, such as computer-readable instructions, data structures, program modules, or other data. Storage system 845 may be implemented as a single storage device but may also be implemented across multiple storage devices or sub-systems. Storage system 845 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 850 is typically mounted on a circuit board that may hold the storage system. The operating software of storage system 845 comprises computer programs, firmware, or some other form of machine-readable program instructions. The operating software of storage system 845 comprises instruction application 824. The operating software on storage system 845 may further include an operating system, utilities, drivers, network interfaces, applications, or some other type of software. When read and executed by processing system 850 the operating software on storage system 845 directs computing system 800 to operate as a head-worn device as described herein. In at least one implementation, the operating software can provide method 200, described in FIG. 2, to provide notifications to a user.

Instruction application 824 directs processing system 850 to generate an instruction for at least one LED positioned on a portion of a frame of computing system 800. Instruction application 824 further directs processing system 850 to emit, from the at least one LED, light, at least partially, in a direction of an eye of a user of the head-worn device based on the instruction. In at least one implementation, instruction application 824 generates the instruction to provide a notification. The notification can include incoming messages, calls, or alerts, system status updates, environmental changes, user interactions, and application-specific events. In some implementations, the instruction can also be used to provide a configuration associated with a diffusion layer or an LCD layer associated with the LED. The diffusion layer can be used to scatter and distribute light evenly to reduce glare, improve uniformity, and enhance visual appearance. The LCD layer can manipulate light by selectively blocking, transmitting, or modulating it to create images or control brightness. For example, the LCD layer can be used to demonstrate a shape that provides information associated with the notification to the user (e.g., an arrow for a volume change).

In some implementations, one or more sensors can provide information to instruction application 824. The one or more sensors can include photodiodes, infrared cameras, and other sensors to identify the information about the user and the environment. In some implementations, the sensors provide data related to the user's gaze. In some implementations, the sensors provide lighting information for the physical environment. The sensor data can be used to increase brightness from the LED when the physical environment is brighter or decrease brightness from the LED when the physical environment is darker. This can improve user recognition of the notification and limit the intrusiveness of the notification in the user's vision. Computing system 800 can further select one or more LEDs to display the notification based on lighting conditions of the environment and the user's gaze. The selection can be used to ensure the notification is in the gaze of the user and provides the desired information to the user. For example, a first LED can be selected when the gaze is in a first direction and a second LED can be selected when the gaze is in a second direction. Computing system 800 can update any other lighting configuration associated with brightness, color, and the like.

Clause 1. A system comprising: a frame of a head-worn device; a controller; and at least one light-emitting diode (LED) positioned on a portion of the frame facing a user of the frame, the at least one LED configured to emit light, at least partially, in a direction of an eye of the user based on an instruction from the controller.

Clause 2. The system of clause 1, wherein the at least one LED comprises a direct view display.

Clause 3. The system of clause 1, further comprising: a diffusion layer configured to blend the light from the at least one LED based on the instruction from the controller.

Clause 4. The system of clause 1, wherein the controller is further configured to: identify lighting in a physical environment for the user; determine a brightness for the light from the at least one LED based on the lighting in the physical environment; and generate the instruction, the instruction indicating the brightness for the light.

Clause 5. The system of clause 1, wherein the controller is further configured to: identify a gaze associated with the user; determine a brightness for the light from the at least one LED based on the gaze; and generate the instruction, the instruction indicating the brightness for the light.

Clause 6. The system of clause 1, further comprising: a liquid crystal display (LCD) layer configured to mask the light from the at least one LED based on the instruction from the controller.

Clause 7. The system of clause 6, wherein the frame comprises a first color, and wherein the LCD layer comprises a second color that resembles the first color.

Clause 8. The system of clause 1, wherein the light is visible in a gaze of the user separate from a lens of the head-worn device.

Clause 9. The system of clause 1, wherein the at least one LED comprises an array of LEDs, and wherein the system further comprises: a liquid crystal display (LCD) layer configured to mask the light from the at least one LED to form a shape.

Clause 10. The system of clause 1, wherein the controller is further configured to: identify a gaze associated with the user; determine a configuration for the light from the at least one LED based on the gaze; and generate the instruction, the instruction indicating the configuration for the light.

Clause 11. The system of clause 10, wherein the controller is further configured to: identify lighting in a physical environment for the user, wherein determining the configuration for the light from the at least one LED is further based on the lighting.

Clause 12. A method comprising: generating an instruction for at least one light-emitting diode (LED) positioned on a portion of a frame of a head-worn device; and emitting, from the at least one LED, light, at least partially, in a direction of an eye of a user of the head-worn device based on the instruction.

Clause 13. The method of clause 12, wherein the at least one LED comprises a direct view display.

Clause 14. The method of clause 12, further comprising: identifying lighting in a physical environment for the user; and determining a brightness for the light from the at least one LED based on the lighting in the physical environment, wherein the instruction indicates the brightness.

Clause 15. The method of clause 12, further comprising: identifying a gaze associated with the user; and determining a brightness for the light from the at least one LED based on the gaze, wherein the instruction indicates the brightness.

Clause 16. The method of clause 12, further comprising: masking, via a liquid crystal display (LCD) layer, the light from the at least one LED based on the instruction.

Clause 17. The method of clause 12, wherein the light is visible in a gaze of the user separate from a lens of the head-worn device.

Clause 18. The method of clause 12, wherein the at least one LED comprises an array of LEDs, and wherein the method further comprises: a liquid crystal display (LCD) layer configured to mask the light from the at least one LED to form a shape.

Clause 19. The method of clause 12, further comprising: identifying a gaze associated with the user; and determine a configuration for the light from the at least one LED based on the gaze, wherein the instruction indicates the configuration.

Clause 20. A system comprising: a frame of a head-worn device; a controller; a display in a lens of the frame, the display comprising at least one optical component; and at least one light-emitting diode (LED) positioned on a portion of the frame facing a user of the frame, the at least one LED configured to emit light, at least partially, in a direction of an eye of the user based on an instruction from the controller.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an” and “the” do not exclude the plural reference unless the context dictates otherwise. Moreover, conjunctions such as “and,” “or,” and “and/or” are inclusive unless the context dictates otherwise. For example, “A and/or B” includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

What is claimed is:

1. A system comprising:
a frame of a head-worn device;
a controller; and
at least one light-emitting diode (LED) positioned on a portion of the frame facing a user of the frame, the at least one LED configured to emit light, at least partially, in a direction of an eye of the user based on an instruction from the controller.

2. The system of claim 1, wherein the at least one LED comprises a direct view display.

3. The system of claim 1, further comprising:
a diffusion layer configured to blend the light from the at least one LED based on the instruction from the controller.

4. The system of claim 1, wherein the controller is further configured to:
identify lighting in a physical environment for the user;
determine a brightness for the light from the at least one LED based on the lighting in the physical environment; and
generate the instruction, the instruction indicating the brightness for the light.

5. The system of claim 1, wherein the controller is further configured to:
identify a gaze associated with the user;
determine a brightness for the light from the at least one LED based on the gaze; and
generate the instruction, the instruction indicating the brightness for the light.

6. The system of claim 1, further comprising:
a liquid crystal display (LCD) layer configured to mask the light from the at least one LED based on the instruction from the controller.

7. The system of claim 6, wherein the frame comprises a first color, and wherein the LCD layer comprises a second color that resembles the first color.

8. The system of claim 1, wherein the light is visible in a gaze of the user separate from a lens of the head-worn device.

9. The system of claim 1, wherein the at least one LED comprises an array of LEDs, and wherein the system further comprises:
a liquid crystal display (LCD) layer configured to mask the light from the at least one LED to form a shape.

10. The system of claim 1, wherein the controller is further configured to:
identify a gaze associated with the user;
determine a configuration for the light from the at least one LED based on the gaze; and
generate the instruction, the instruction indicating the configuration for the light.

11. The system of claim 10, wherein the controller is further configured to:
identify lighting in a physical environment for the user,
wherein determining the configuration for the light from the at least one LED is further based on the lighting.

12. A method comprising:
generating an instruction for at least one light-emitting diode (LED) positioned on a portion of a frame of a head-worn device; and
emitting, from the at least one LED, light, at least partially, in a direction of an eye of a user of the head-worn device based on the instruction.

13. The method of claim 12, wherein the at least one LED comprises a direct view display.

14. The method of claim 12, further comprising:
identifying lighting in a physical environment for the user; and
determining a brightness for the light from the at least one LED based on the lighting in the physical environment,
wherein the instruction indicates the brightness.

15. The method of claim 12, further comprising:
identifying a gaze associated with the user; and
determining a brightness for the light from the at least one LED based on the gaze,
wherein the instruction indicates the brightness.

16. The method of claim 12, further comprising:
masking, via a liquid crystal display (LCD) layer, the light from the at least one LED based on the instruction.

17. The method of claim 12, wherein the light is visible in a gaze of the user separate from a lens of the head-worn device.

18. The method of claim 12, wherein the at least one LED comprises an array of LEDs, and wherein the method further comprises:
a liquid crystal display (LCD) layer configured to mask the light from the at least one LED to form a shape.

19. The method of claim 12, further comprising:
identifying a gaze associated with the user; and
determine a configuration for the light from the at least one LED based on the gaze,
wherein the instruction indicates the configuration.

20. A system comprising:
a frame of a head-worn device;
a controller;
a display in a lens of the frame, the display comprising at least one optical component; and
at least one light-emitting diode (LED) positioned on a portion of the frame facing a user of the frame, the at least one LED configured to emit light, at least partially, in a direction of an eye of the user based on an instruction from the controller.
